(19) United States
(12) Patent Application Publication
(10) Pub. No.: US 2007/0260675 A1
(43) Pub. Date: Nov. 8, 2007

(54) Method and system for adapting a single-client, single-user application to a multi-user, multi-client environment

(76) Inventors: Clifton L. Forlines, Brookline, MA (US); Alan W. Esenther, Ashland, MA (US); Chia Shen, Lexington, MA (US); Daniel J. Wigdor, Toronto (CA); Kathleen Ryall, Wayland, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/430,234

(22) Filed: May 8, 2006

(51) Int. Cl. G06F 15/16

(52) U.S. Cl. 709/203

(57) ABSTRACT

The invention provides a method and system for adapting a single-user, single-client application for multiple clients operated by multiple users. An instance of an unmodified single-client, single-user application is executed in each of the clients, and the execution of the multiple instances of the application is coordinated by a wrapper application executing in each of the clients. The wrapper application is configured to communicate messages between the clients via a network to facilitate the coordination.

### FIELD OF THE INVENTION

This invention relates generally to graphical applications, and more particularly to adapting single-client, single-user graphical applications to multiple clients and multiple displays for multiple users.

### BACKGROUND OF THE INVENTION

Typically, graphical applications are displayed on conventional desktop or laptop display screens of single-user computer systems (clients). Single-user clients, such as PCs and laptops, can include more than one display screen. However, most commercially available applications are not designed to be operated by multiple users or interfaced to multiple displays. Furthermore, many applications only allow a single instance of the application to execute in the client at any one time. This makes the execution of multiple copies of the application, with each copy of the application displaying on a separate display, impossible.

A multi-user, shared-view graphical application is described generally by Greenberg, “Sharing views and interactions with single-user applications,” Proceedings of the ACM, IEEE Conference on Office Information Systems, pp. 227-237, 1990. The focus of that work is to ensure that a remote computer controls and maintains a state in memory so that users who are physically separated from one another are presented with the same ‘view’ of the graphical application. With that shared view, separated users have a shared context for collaboration.

Another method for remote collaboration is commonly referred to as “screen sharing.” In that method, a single instance of an application executes only on a server computer (server), and images are sent to any number of remote clients. Remote users of the clients can interact with the application by sending input events over the network from the clients to the server. A consistent view of the application is maintained across all clients and the server because there is only a single instance of the application executed on the server.

Finally, there are multi-user applications programmed to execute on multiple clients at remote locations, each client operated by a single user. Most commonly, multi-player games and chat applications each execute as a separate instance of the application on each client. The users of the clients communicate with each other via a ‘controlling’ server. The server controls how the client application executes. Those applications are specifically designed and programmed to execute in this distributed manner. In essence, the clients have no control how the application executes. Furthermore, the users have no way to modify the operation of the multi-user application.

In a network based computing environment, e.g., the Internet, users of clients frequently download single-user applications from servers. The single-user applications are executed individually and separately by the single users of each client. Such applications are programmed to execute only on a single client and to be operated only by a single user. Such applications cannot execute in a multi-computer, multi-user environment without reprogramming the application. Reprogramming an application is expensive and often impossible due to the proprietary nature of most applications provided by the servers.

Therefore, it is desired to adapt single-client, single-user applications to multi-client, multi-user environments without modifying the underlying application.

### SUMMARY OF THE INVENTION

The embodiments of the invention provide a method and system for adapting single-client, single-user applications to multi-client, multi-user environments. In particular, the application can be a graphical application, and it is desired to coordinate images rendered by the application so that the multiple users can collaborate, even while the clients and users are geographically distributed. Furthermore, a client can include multiple display devices that each render images with different ‘views.’

Specifically, the embodiments provide an interface for a graphical geospatial application, Google Earth. This allows multiple users to view maps and related satellite images in a collaborative and distributed manner using multiple clients and multiple display devices.

The system can use multi-user, multi-touch sensitive display devices; vertical wall displays; and desktop, laptop and handheld computer systems.

Specifically, one embodiment of the invention provides a method and system for adapting a single-user, single-client application for multiple clients operated by multiple users. An instance of an unmodified single-client, single-user application is executed in each of the clients, and the execution of the multiple instances of the application is coordinated by a wrapper application executing in each of the clients. The wrapper application is configured to communicate messages between the clients via a network to facilitate the coordination.

### BRIEF DESCRIPTION OF THE DRAWINGS

FIG. 1 is a block diagram of a system for adapting a graphical application according to an embodiment of the invention;

FIG. 2 is a block diagram of an unmodified single-user, single-user application executing on a server and clients according to an embodiment of the invention;

FIG. 3 is a block diagram of a wrapper application according to an embodiment of the invention;

FIG. 4 is a block diagram of overlaid display elements according to an embodiment of the invention;

FIG. 5 is block diagram of a sever and clients according to an embodiment of the invention;

FIGS. 6A-6C are images with overlay elements for controlling transformations of point-of-views according to an embodiment of the invention; and

FIG. 7 shows a workspace with three clients according to an embodiment of the invention.

### DETAILED DESCRIPTION OF THE PREFERRED EMBODIMENT

System Structure

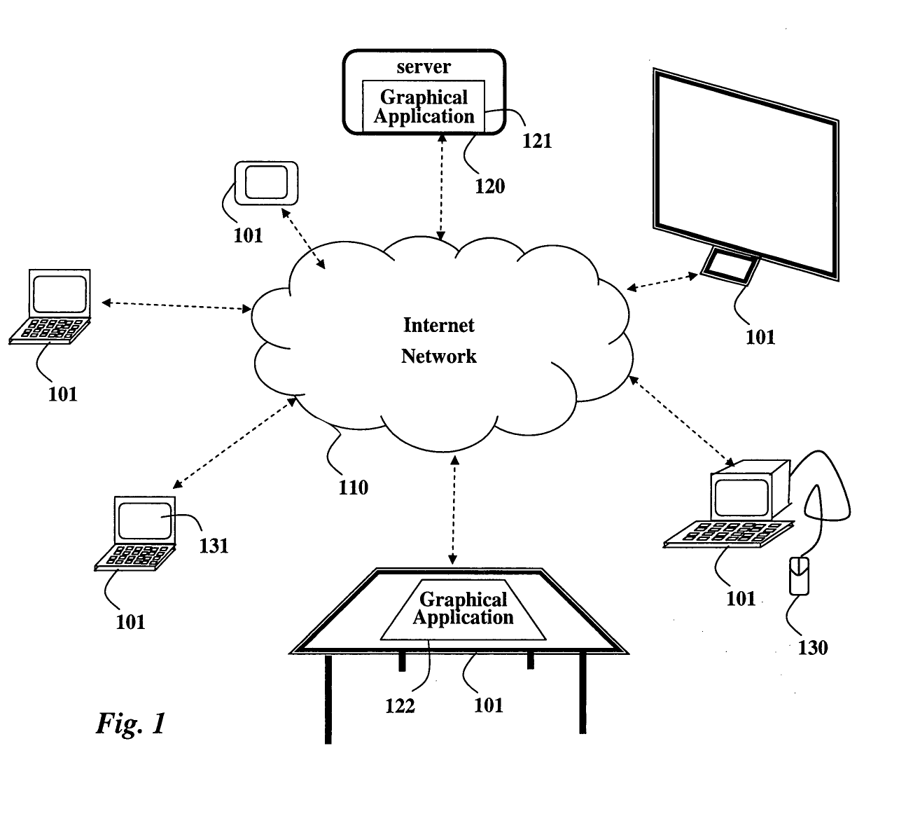

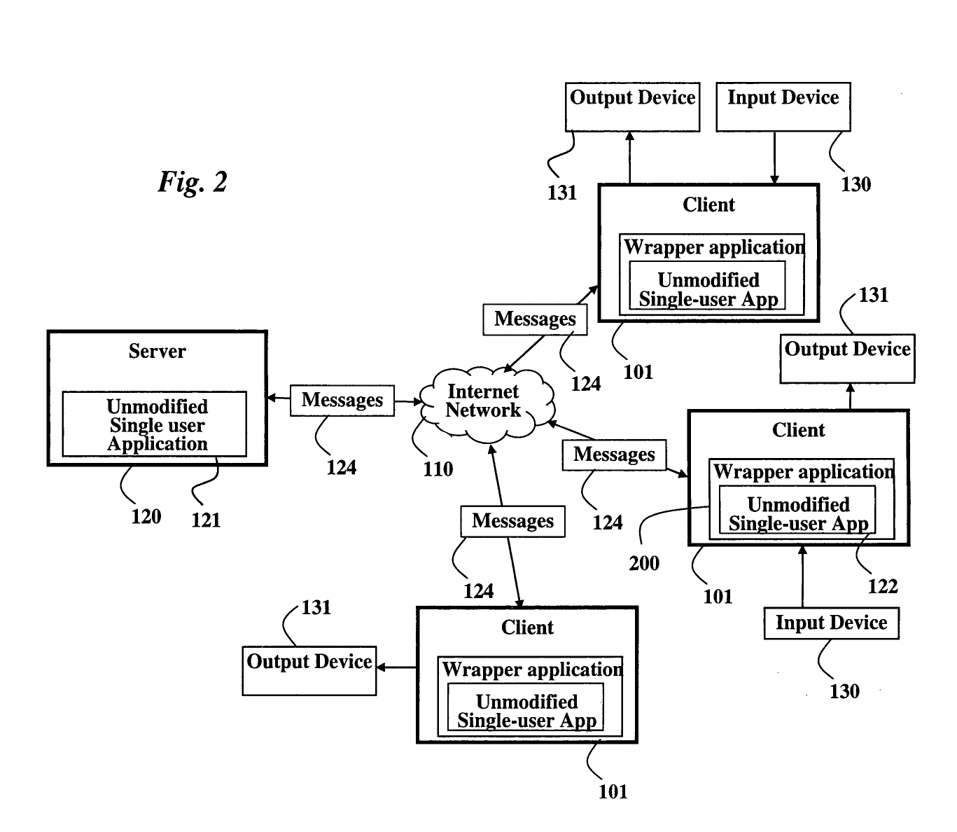

FIGS. 1 and 2 show a system for adapting a single-client, single-user application according to an embodiment of our invention. The system includes multiple client computer systems (clients) 101. The clients can include desktop systems, laptop systems, handheld systems, systems with wall-mounted displays, and systems with table-top displays. The clients can be collocated or widely distributed geographically. Each client executes an instance of the single-client, single-user application. The execution of the application is coordinated among the users.

Each client 101 includes a processor, memory, and I/O interfaces. Each client can also include a user input device 130, such as a keyboard, a mouse or a touch-sensitive surface. Each client can also include user output devices 131, for example, one or more display devices. The terms ‘user input’ and ‘user output’ as used herein are used to distinguish over other input/output devices that are not directly controlled by or visible to the user, such as communication interfaces, storage interfaces, and the like. In one embodiment of the invention and in contrast with the prior art, a client can operate the application even if the client does not include user input devices, i.e., the client only includes one or more user output devices. In another embodiment of the invention and in contrast with the prior art, a client can display different views rendered by the application on multiple displays.

The clients can be interconnected via a network 110, e.g., the Internet. The clients systems can execute applications. The applications can include applications stored on the client systems or applications that are downloaded via the network from a ‘website’ or server computer 120 using browser applications executing in the client computers. In the case of downloaded applications, a server part 121 of the application executes on the server 120, while a client part 122 executes on one of the clients 101. As stated above, the execution of the single-client, single-user application is coordinated in the multiple clients.

According to an embodiment of the invention, the application is a graphical geospatial application, such as Google Earth. However, it should be understood that the embodiments of the invention can also be adapted to other graphical applications. The Google Earth application can display maps and related satellite images.

Generally, geospatial applications provide a user with tools that can be used to navigate to any position on the globe using the maps, and to augment corresponding satellite images with geo-registered information, such as roads, buildings, and geographic boundaries. Typically, the augmented maps and images are displayed on conventional desktop or laptop display screens of single-user clients. It is desired to adapt geospatial applications to multiple concurrent users at dispersed locations.

It should also be understood that such graphical applications are designed to be executed only on a single-display, single-client computer and operated by a single user in isolation and entirely independent of any other instances the application downloaded by other clients. Furthermore, it should be understood that such server-supplied applications are generally extremely proprietary, and cannot readily be modified by the client computers to their specifications.

It is goal of the embodiments of our invention to adapt the graphical application 121-122 so that multiple users of multiple client computers at multiple locations can concurrently collaborate with the application in a synchronized manner. For this purpose, the system uses messages 124.

Furthermore, it is desired to adapt the graphical application for multi-user, multi-system operations without modifying the underlying application 121-122 as shown in FIG. 2.

Therefore, as shown in FIG. 2, the embodiments of the invention provide a ‘wrapper’ application 200 for each instance 122 of the graphical application. As stated above, our wrapper application adheres to the premise that the underlying or ‘wrapped’ graphical application 121-122 is not modified.

Both the wrapper application 200 and the unmodified client portion of the graphical application 122 run on each client 101 in the system in a coordinated manner.

Wrapper

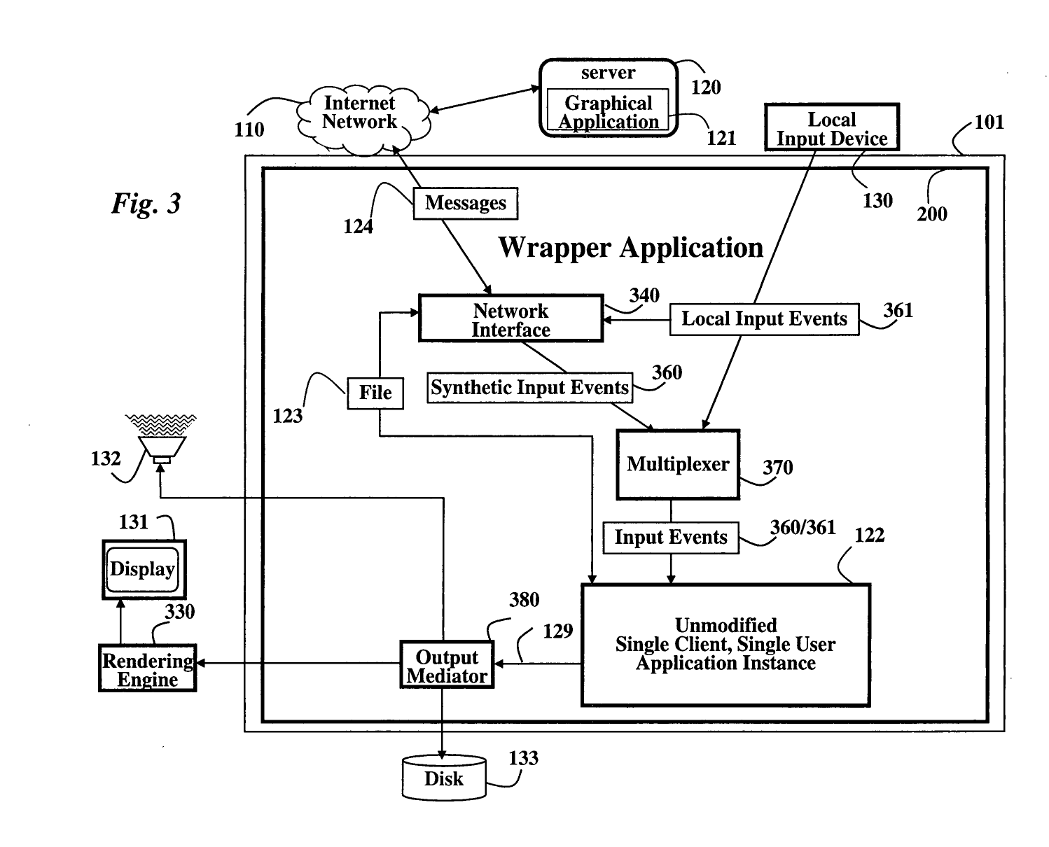

FIG. 3 shows our wrapper application 200 that overlays the unmodified client portion of the graphical application with additional interface elements not provided by the application 122.

The wrapper application includes a network interface 340 for communicating messages 124. Received messages 124 are used by the network interface 340 to generate ‘synthetic’ input events 360 that are compatible with the unmodified application 122. The ‘synthetic’ input events 360 are passed to a multiplexer 370 along with ‘real’ local input events 361 generated by a local input device 130 connected to the client 101. The multiplexer 370 controls which input events 360/361 are passed to the unmodified graphical application 122 in a selected manner to coordinate the execution of the application.

In one example of the invention, the graphical application 121-122 is a geospatial application that downloads and renders geospatial information, such as maps, satellite images, and what are called registered layers of information, for example, labeled roads, business locations, geographical boundaries, etc.

The information is displayed by a rendering engine 330 on the display 131 according to the input events. As described below, the rendering engine can process various data types and graphical elements as known in the art.

In one embodiment of our invention, all output 129 from the unmodified graphical application 122 is redirected to and intercepted by an output mediator 380. Although the output 129 is primarily graphical in nature, the output can also includes other data streams generated by the unmodified application, such as video streams, audio streams and file streams. Therefore the output mediator 380 modifies the intercepted output 129 before sending it to output devices, such as the display 131, speaker 132, and disk 133.

Thus, by intercepting all input to the unmodified application 122 by the network interface 340 and the multiplexer 370, and all output 129 from the unmodified application 122 by the output mediator 380, it is possible for the wrapper 200 to ‘isolate’ the unmodified application from direct input and direct output so that the input and output and the execution of the application happens in a coordinated manner among the various clients and users.

In one embodiment, the messages 124 from the server 120 can contain latitude and longitude information so that each client 101 in the system displays information pertaining to the same location on the earth.

Messages 124 from the server can include files 123 encoded according to the keyhole language (KML). KML is a grammar and file format for modeling and storing geographic features such as points, lines, images, and polygons for display in maps and images. The KML file is processed by the geospatial application 122 in a similar way that HTML and XML files are processed by web browsers. Like HTML, KML has a tag-based structure with names and attributes used for specific display purposes. Thus, the geospatial application 122 acts as a browser of the KML file 123.

Messages 124 from the server can include commands that are sent to the multiplexer 370 that controls the operation the multiplexer 370.

Displaying Additional Interface Elements

With potentially many instances of the client application executing in the environment, users can benefit from interface and coordination components that are not part of the single-client, single-user application 122. For example, a group of users working collaboratively at one or more locations with many instances of the application executing on multiple clients and having multiple displays can benefit from each display having a uniquely identifiable visual element. Thus, users can reference specific instances of the application when collaborating with other users.

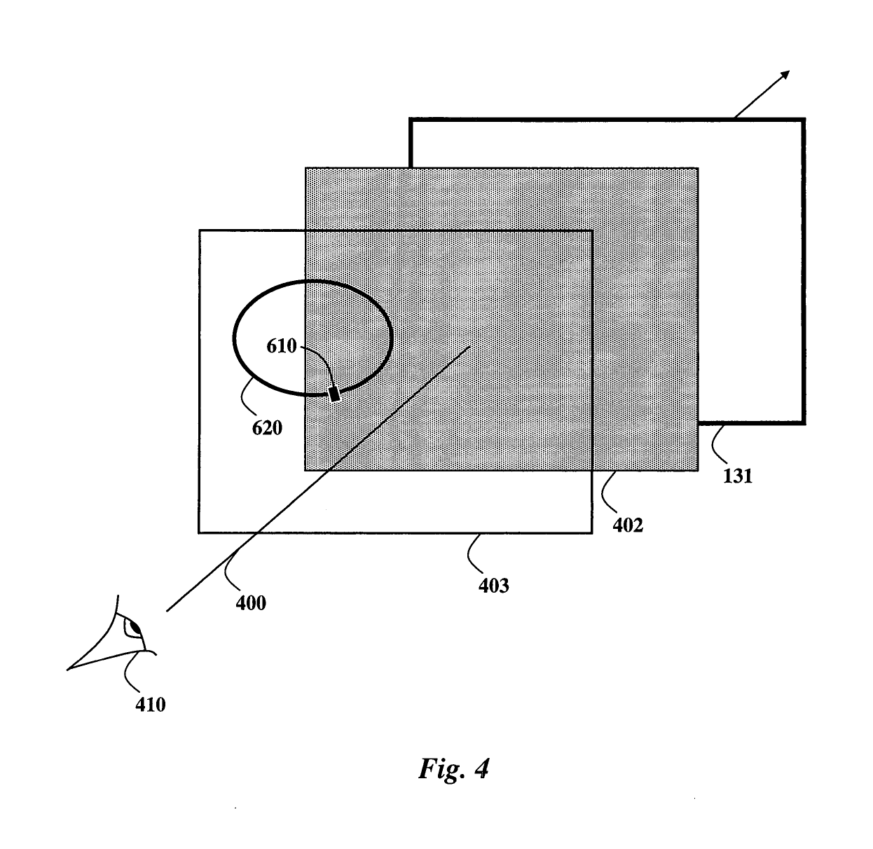

As shown in FIG. 4, the ‘normal,’ unmodified output 402 of the unmodified graphical application 122 is rendered to the display 131 by the rendering engine 330. The rendering engine also displays a transparent overlay 403 on top of the unmodified graphical output 402. By ‘on top of,’ we mean that the overlay 403 is in front of the unmodified output 402 in a front-to-back order 400 with respect to a viewer 410.

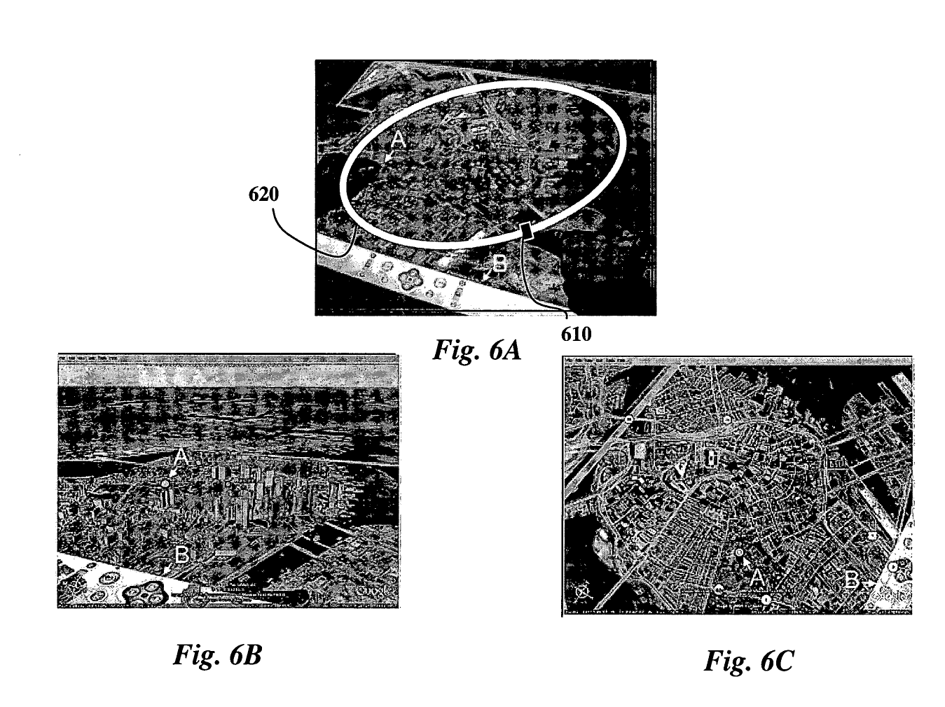

The transparent overlay can include additional opaque or translucent graphical elements 610 and 620 not contemplated by the unmodified graphical application, see also FIG. 6A.

Synchronized and Coordinated Views

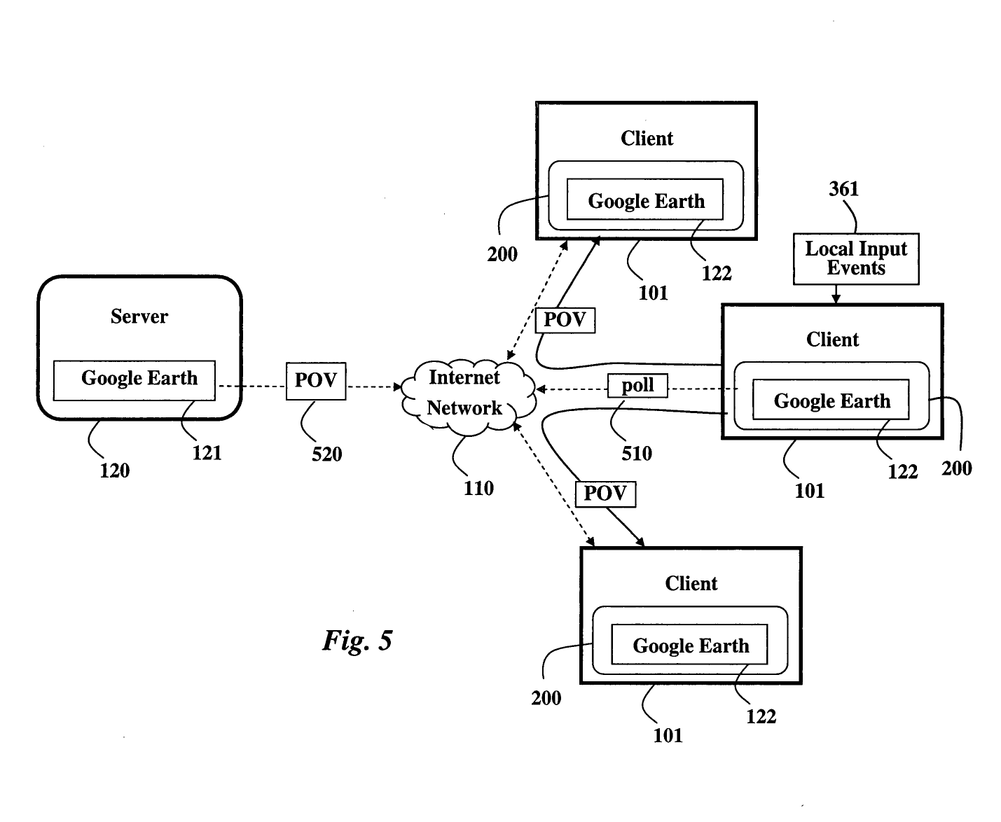

As shown in FIGS. 2, 3, and 5, the wrapper application 200 synchronously coordinates the displayed information by the multiple clients 101. When a user generates a local input event 361 using the local input device 130, the wrapper application 200 passes this input event as a message 124 over the network 110 to the other clients. The term “synchronized and coordinated views” specifically refers to our design in that the input event 361 is modified before the event is sent to the other clients.

In an embodiment of the invention, the wrapper application 200 polls 510 the server portion 121 of the unmodified geospatial application for a current point-of-view (POV) 520 displayed by the application. The POV is expressed in terms of latitude, longitude, zoom factor, viewing angle, etc. In response, the server replies the POV 520, which can be distributed to all clients via the network. Then, each client sets the POV accordingly for the local instance of the application 122. In general, this modification never changes the latitude and longitude that is the focus of the POV. Consequentially, all clients view the same location on the earth, perhaps from different angles and zoom levels. It should be noted that the images for the POV at each client can be time-shifted with respect to each other.

Input Transformation

It may be necessary to perform a transformation of the POV because of different orientations of display devices. For example, some display devices are oriented in a vertical plane, while other devices are oriented in a horizontal plane. For vertical displays, the users are usually positioned in front of the display, so all users essentially have the same view of the display. In the case of a horizontal display, such as a table top, different users around the table have different views of the display. For instance, the display maybe inverted for some users and sideways for other users. Thus, a POV for one display may be inappropriate for another display.

FIGS. 6A-6C show three different views for the same geospatial location, e.g., downtown Boston, Mass., U.S.A. In these figures, the white letters A and B are added to in the images for clarity of this description. All views focus on the same geospatial location from different views with different layers of information. The view for a tabletop display device, as shown in FIG. 6A, is a bird's-eye-view. The view for a wall-mounted vertical display device, as shown in FIG. 6B, shows a ¾ view with 3D buildings overlaid. The view in FIG. 6C, also for a vertical display, shows a wider bird's eye view overlaid with roads.

Rendering Separating Layers

If the display devices for the views shown in FIGS. 6A-6C are co-located, a user at that location can see the different views at the same time. This is an advantage. The geospatial application can augment the views with different layers of information. Thus, the end result is a spatially-multiplexed, temporally-synchronized, multi-layered display. Simultaneously displaying these multiple layers on a single-display would produce a visually cluttered and less-useful image, and switching amongst these layers sequentially on a single display might also impose high levels of cognitive load on the users.

By simultaneously displaying the same information in multiple ways, a user may understand the information through different perspectives, and overcome possible misinterpretations. This improves an interactive and investigative visualization through correlating the information among the different views.

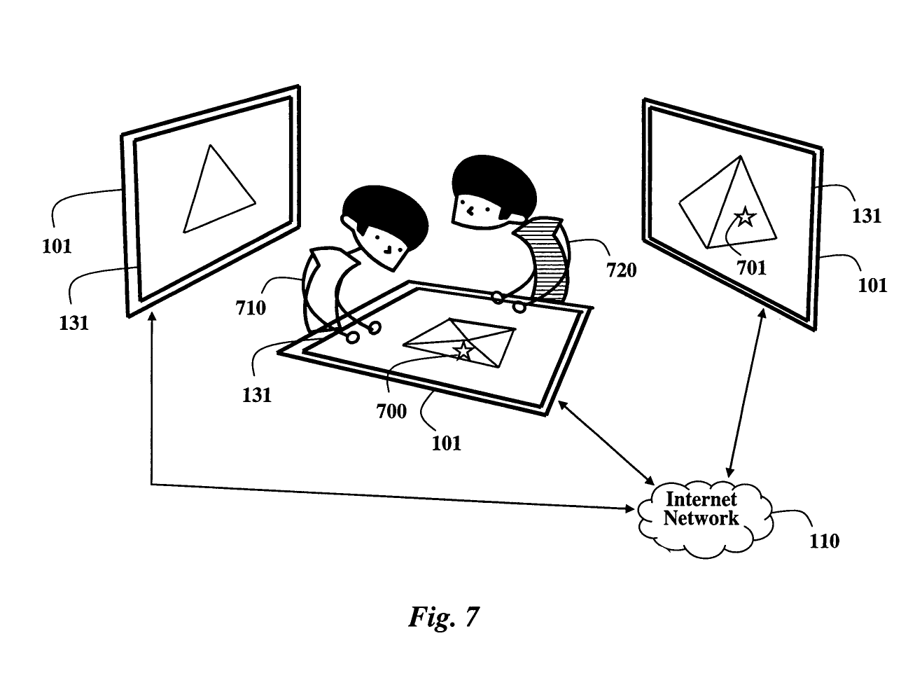

FIG. 7 shows two users 710-720 working in a workspace that includes three clients 101, two of which have wall displays 131 and one of which has a tabletop display 131. On the tabletop display, the unmodified graphical application displays a bird's eye view of a pyramid. On the left wall display, the same pyramid is displayed from a distinct POV in a separate instance of the unmodified graphical application. On the right wall display, a third instance displays yet another POV of the same object. A visual marker 700 drawn by one of the users on the tabletop display 131 is shown in the correct location 701 on the right wall display relative to the pyramid.

Controlling View Transformations

In one embodiment of the invention, the default POV for a horizontal tabletop display device is the bird's eye view as shown in FIG. 6A. This view assumes that users are positioned around a table and looking down on the displayed images. For each co-located vertical display, the POV is transformed based on a spatial relationship between the physical wall-mounted display and the table top display.

The default POV transformation generates a non-contiguous collection of views, similar to those described by Cruz-Neira et al., “The CAVE: Audio Visual Experience Automatic Virtual Environment,” Communications of the ACM, vol. 35, no. 6, pp. 65-72, June 1992, incorporated herein by reference. This gives an intuitive feel, one with the most natural initial relationship between views, although not the only useful one.

On the horizontal display, the view of each vertical display is represented with a proxy camera 610. The position of the proxy camera indicates the rotation and tilt of the view of the vertical display relative to the table top, as further indicated by a control ring 620. The proxy camera of the touch-sensitive horizontal display device can be used to change the orientation and tilt of the view in the vertical display. By changing views in this manner on the table, users do not have to stand up and walk to another display to manipulate its view. It is also possible to perform input for the vertical displays, which may have no input mechanism of its own.

The proxy camera and the control ring can be displayed using the overlay mechanism as described for FIG. 4.

Dragging the proxy camera around the center of the tabletop display in either direction rotates the POV of the vertical wall display. Dragging the proxy camera toward or away from the center of the tabletop changes the tilt of the POV of the vertical wall display. By constraining POV transformations to rotation and tilt, there is a very natural mapping between a two-degree-of-freedom touch input on the tabletop and these two values in the POV.

While altering the POV for a wall-mounted vertical display enables a group of users to view different angles of a scene, thus revealing different aspects of the underlying data, it can quickly become difficult to understand the relationship between what is displayed vertically and horizontally.

Detaching and Re-Synchronizing Views

It is possible to break the coordination of views between a wall display and the table top display. For example, a group of users may want to view some other locations. The coordination can be temporarily broken and linked again at a later time.

Annotations

In geospatial applications, annotation is a major activity. Our system and method provides a multi-user annotation tool. Our annotation tool ‘paints’ into the transparent overlay 403 of displayed images 402, and polls 510 the geospatial application for the geospatial location of the current point-of-view 520 so that annotation strokes can be registered geospatially.

This way, when the annotation completes, the annotations can be passed over the network to other clients, and displayed in the correct location regardless of the client's current or future POVs.

Specifically, the file 123 includes the KML file detailing geospatial location and a bitmap file containing the annotation. The file 123 is sent over the network 110 to the other clients 101. The other clients can than open the KML file, which inserts the bitmap file into the rendering engine 330 of the geospatial application 122.

Working Together, Working Alone

A major benefit of a collaborative display is the common context that the display provides to a group of users. However, situations arise in which the use of a shared display is not advantageous.

Most single-user graphical applications have pop-up menus or modal dialogue boxes that can occupy a large portion of the displayed image. For example, when a user wishes to turn layered information on and off, the user opens a layer control panel that can occupy up to ⅓ of the display. As described above, users often switch between periods of collaborative and independent work. If the users are working closely together, the opening of this menu would be expected and not cause an interruption. However, when working independently, opening a large menu is a disruptive action for other users.

A person using our system may mediate this particular disruption by performing input with disruptive visual feedback on a client machine. Once the input is complete, the results of the input are sent to the appropriate client. In this manner, the modified feature of the application is synchronized between the various clients, allowing an individual to issue these commands without disrupting the shared display.

Touching to Navigate, Touching to Reference

Because most off-the-shelf applications and downloadable applications assume a single client and a single user, many commands are not well defined when performed simultaneously by multiple users. In our example application, different users can issue conflicting commands. One way to mediate this is to process only the command that is due to the first touching.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for adapting a single-user, single-client application for a plurality of clients operated by a plurality of users, comprising the steps of:
executing an instance of an unmodified single-client, single-user application in each of a plurality of clients; and
coordinating the executing of each instance of the single-client, single-user application with a wrapper application executing in each of the plurality of clients, the wrapper application configured to communicate messages between the plurality of clients via a network.

2. The method of claim 1, further comprising:
downloading the single-client, single-user application to the plurality of clients via a network.

3. The method of claim 1, in which at least one client includes only user output devices.

4. The method of claim 1, in which at least one client includes a plurality of user output devices.

5. The method of claim 1, in which the single-client, single-user application includes a client portion executing on the each of the plurality of clients, and a server portion executing on a single server, and in which the server and the plurality of clients are connected by a network.

6. The method of claim 1, in which the single-client, single-user application is a graphical application, and the coordinating applies to images displayed by the graphical application for the plurality of clients.

7. The method of claim 6, in which the graphical application is a geospatial application, and the images include maps and satellite images.

8. The method of claim 1, in which a subset of the clients are collocated.

9. The method of claim 1, in which a subset of the clients are geographically distributed.

10. The method of claim 6, in which views of the images are coordinated among the plurality of clients.

11. The method of claim 1, in which the wrapper application includes a network for communicating the messages.

12. The method of claim 1, in which the wrapper application includes a multiplexer for receiving synthetic input events via the messages and real input events from user input devices, and further comprising:
passing selectively the synthetic input events and the real input events to the single-client, single-user application to coordinate the executing.

13. The method of claim 1, in which the single-client, single-user application processes files formatted according to a keyhole markup language.

14. The method of claim 7, in which the messages include a point-of-view.

15. The method of claim 14, in which the point-of-view includes latitude and longitude information.

16. The method of claim 14, further comprising:
displaying an overlay indicative of the point-of-view on user output devices.

17. The method of claim 14, further comprising:
polling a server portion of the single-client, single-user application for the point-of-view.

18. The method of claim 12, in which the messages include commands that control an operation of the multiplexer.

19. The method of claim 6, in which views of the images are time shifted with respect to each other.

20. The method of claim 1, in which the wrapper application intercepts all input data intended for the single-client, single-user application, and the wrapper application intercepts all output data generated by the single-client, single-user application.

21. The method of claim 20, in which a network interface intercepts the messages, an input multiplexer intercepts user input data, and an output mediator intercepts the output data.

22. The method of claim 21, in which the output data are selected from the group consisting of graphical data, video data, audio data, file data, and combinations thereof.

23. A system for adapting a single-user, single-client application for a plurality of clients operated by a plurality of users, comprising the steps of:
means for executing an instance of an unmodified single-client, single-user application in each of a plurality of clients; and
means for coordinating the executing of each instance of the single-client, single-user application with a wrapper application executing in each of the plurality of clients, the wrapper application configured to communicate messages between the plurality of clients via a network.
